(19) United States
(12) Patent Application Publication
(10) Pub. No.: US 2020/0142477 A1
(43) Pub. Date: May 7, 2020

(54) IR FACETRACK SYSTEM METHOD OF INTEGRATION INTO AUTOMOTIVE HEADS UP DISPLAY

(71) Applicant: Panasonic Automotive Systems Company of America, Division of Panasonic Corporation of North America, Peachtree City, GA (US)

(72) Inventors: STEVEN L. SMITH, PUTNAM VALLEY, NY (US); MARKAR NARADIKIAN, TUCSON, AZ (US)

(73) Assignee: Panasonic Automotive Systems Company of America, Division of Panasonic Corporation of North America

(21) Appl. No.: 16/669,115

(22) Filed: Oct. 30, 2019

Related U.S. Application Data
(60) Provisional application No. 62/754,897, filed on Nov. 2, 2018.

(51) Int. Cl. G06F 3/01; G02B 27/01

(52) U.S. Cl. CPC G06F 3/012; G06F 3/013; H04N 5/33; G02B 27/0179; G02B 27/0149; G02B 27/0101

(57) ABSTRACT

A head up display arrangement is for a motor vehicle having a human driver. The arrangement includes a picture generation unit producing a light field. A light-reflective mirror reflects the light field such that the light field is visible to the driver as a virtual image. The mirror is transmissive of infrared energy. An infrared energy emitter emits infrared energy through the mirror such that the infrared energy is reflected off of a face of the driver. An infrared camera detects the reflected infrared energy after the reflected infrared energy passes through the mirror a second time.

### CROSS-REFERENCED TO RELATED APPLICATIONS

This application claims benefit of U.S. Provisional Application No. 62/754,897 filed on Nov. 2, 2018, the disclosure of which is hereby incorporated by reference in its entirety for all purposes.

### FIELD OF THE INVENTION

The disclosure relates to a head up display (HUD) and infrared face tracking system in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Driver face tracking systems are known, and occupy a separate and additional space from the HUD.

### SUMMARY

The present invention may provide a driver face tracking system inside of a head up display (HUD). The driver face tracking system may be located behind an infra-red (IR) transmitting cold mirror of the HUD. The driver face tracking system may use an existing HUD optical system for co-aligning the out-going IR illumination and the returning IR image to the same driver face tracking system camera. The cold mirror's visible light-reflective properties and IR-transmissive properties are advantageous for use in the IR face tracking system. The location of the cold mirror enables accurate co-location of the IR illumination and image capture along the outgoing optical path of the HUD virtual image propagation optics. An advantageous location for the IR camera is close to the main fold mirror in order to increase the field of view, and a location that is aligned with the optical axis of the liquid crystal display (LCD) to the fold mirror chief ray.

A visible light reflective component may propagate the picture generation unit (PGU) illumination or light field toward further optics in the system. The visible light reflecting component may be IR transmissive for appropriate IR wavelengths such that the reflected visible light and the transmitted IR energy are co-located and share the same the optical paths.

The present invention may solve four key issues. First, the invention may provide accurate optical alignment of the face tracking system within an appropriate HUD component such that no other OEM space needs to be allocated to implement face tracking.

Second, the invention may enable the IR cold mirror to pass IR illumination from the IR emitters and back to the IR camera and yet reflect visible light from the LCD (PGU). In this configuration, the face tracking system can utilize this location and the remaining optical elements to accurately deliver IR energy and visible light to the location of the driver, optimizing the IR illumination ray bundle in the direction of the driver, and returning the reflected ray bundle to the IR camera. The IR cold mirror IR band pass allows a wide range of IR illumination to satisfy the condition.

Third, the invention may have a lower cost to implement because it leverages the existing HUD housing (with some modification), the existing IR cold mirror, and the existing astigmatic curved reflective mirror. The invention also utilizes the same windshield location as the driver's gaze direction.

Fourth, the invention may improve detection of the driver's gaze direction, as the forward gaze location and the HUD virtual image location are co-located or the gaze direction is directly above the virtual image location, and is just above the front extent of the car above the front bumper.

In one embodiment, the invention comprises a head up display arrangement for a motor vehicle having a human driver. The arrangement includes a picture generation unit (PGU) producing a light field. A light-reflective mirror reflects the light field towards the windshield at an angle such that the light field is visible to the driver as a virtual image. The high reflective mirror is also transmissive of infrared energy. An infrared energy emitter emits infrared energy through the mirror such that the infrared energy passes through the mirror a first time, up to the windshield then directed towards the driver and such that the infrared energy is reflected off of a face of the driver. This infrared energy is then reflected back towards the windshield and down the same optical path where an infrared camera detects the reflected infrared energy after the reflected infrared energy passes through the mirror a second time.

In another embodiment, the invention comprises a head up display method for a motor vehicle having a driver. A light field is produced. A light-reflective mirror is used to reflect the light field such that the light field is visible to the driver as a virtual image. The mirror is transmissive of infrared energy. Infrared energy is emitted through the mirror such that the infrared energy passes through the mirror a first time, and such that the infrared energy is reflected off of a face of the driver. The reflected infrared energy is detected after the reflected infrared energy passes through the mirror a second time.

In yet another embodiment, the invention comprises a head up display arrangement for a motor vehicle having a human driver. A picture generation unit produces a light field. A light-reflective mirror provides a first reflection of the light field. The mirror is transmissive of infrared energy. Two infrared energy emitters emit infrared energy through the mirror. A reflector provides a first reflection of the infrared energy such that the infrared energy is reflected off of a face of the driver and a second reflection of the infrared energy is provided by the reflector. The reflector provides a second reflection of the light field such that the light field is visible to the driver as a virtual image. An infrared camera detects the second reflection of the infrared energy after the second reflection of the infrared energy passes through the mirror.

An advantage of the present invention is that it does not require additional space to be allocated for the face tracking system to be implemented in the vehicle, as would other potential face tracking systems that are not included in the HUD system. The present invention enables the same space to be used for the HUD and the face tracking system. In other potential face tracking systems that are not included in the HUD system, the space needed for the electronics is a problem that would need to be addressed.

Another advantage of the present invention is that the IR camera is co-aligned with the HUD optical axis. In contrast, the IR camera in other systems is not co-aligned with the HUD optical axis. In this embodiment the face tracking system through its use of the common HUD optical elements described above may always be aligned with the driver's face without the use of additional optics.

Yet another advantage is that the face tracking system and the HUD may share common optical components, such as a common reflector.

### BRIEF DESCRIPTION OF THE DRAWINGS

A better understanding of the present invention will be had upon reference to the following description in conjunction with the accompanying drawings.

FIG. 1 is a schematic top view of one embodiment of a HUD and face tracking system of the present invention.

FIG. 2 is a schematic side view of the HUD and face tracking system of FIG. 1.

FIG. 3 is a flow chart of one embodiment of a head up display method of the present invention for a motor vehicle having a driver.

### DETAILED DESCRIPTION OF THE PREFERRED EMBODIMENTS

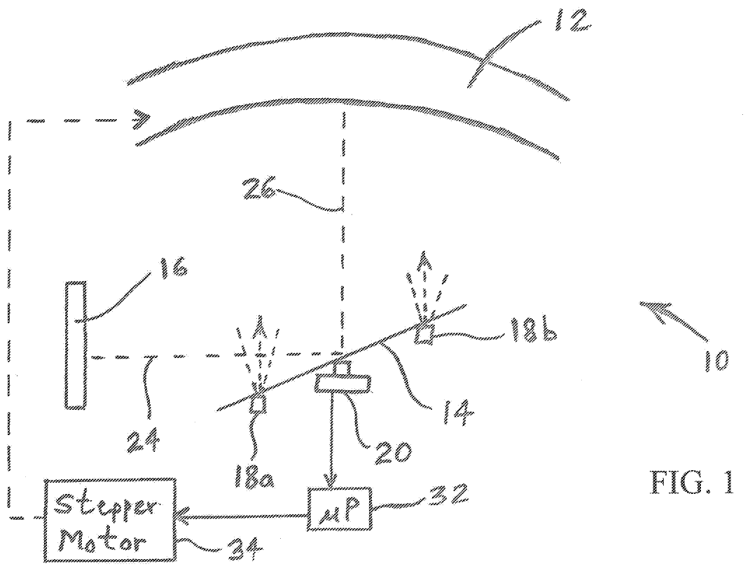

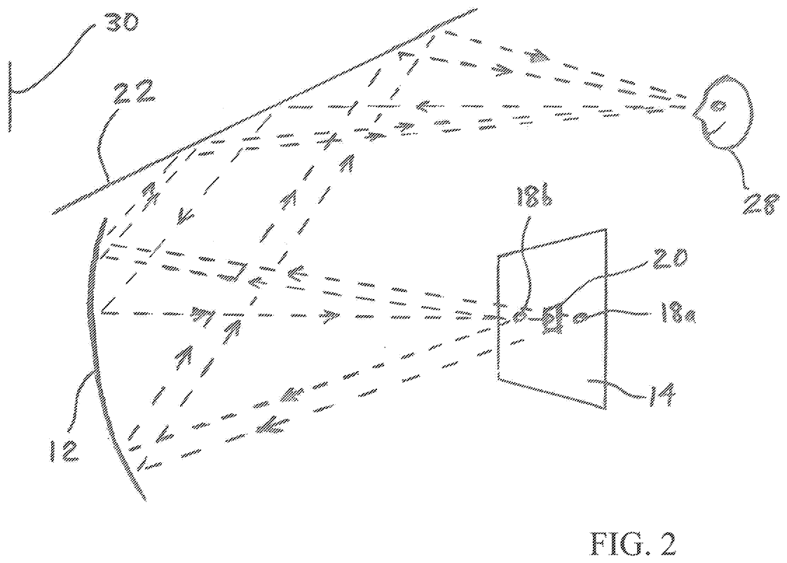

FIG. 1 illustrates one embodiment of a HUD and face tracking system 10 of the present invention including a parabolic/aspheric up reflector 12, a cold fold mirror 14, a PGU in the form of an LCD 16, IR emitters 18a-b, an IR camera 20, and a windshield 22 (FIG. 2). Cold fold mirror 14 may be reflective of visible light and transmissive of IR energy.

During use, LCD 16 produces a light field that propagates along optical path 24 before being reflected by mirror 14 and continuing along optical path 26. The light field then reflects off of reflector 12 and is again reflected off of windshield 22 such that the light field is visible to a human driver 28 as a virtual image 30.

IR energy emitted from IR emitters 18a-b transmits through mirror 14, reflects off of reflector 12 and is again reflected off of windshield 22 before being yet again reflected off of the face of driver 28. The IR energy reflected off of the face of driver 28 reflects sequentially off of windshield 22 and reflector 12 before passing through mirror 14 and being received by IR camera 20 along optical path 26. Thus, the visible light that forms virtual image 30 may share the same optical path 26 as the IR energy received by camera 20. That is, the visible light that forms virtual image 30 may be aligned with the IR energy received by camera 20 along optical path 26.

The output signals of IR camera 20 may be received by an electronic processor 32 that performs tracking of the location of the driver's face and/or eyes based on the signals from camera 20. Based on the location of the driver's face and/or eyes, processor 32 may control an actuator in the form of a stepper motor 34 to adjust the three-dimensional orientation of reflector 12 such that driver 28 can better see virtual image 30.

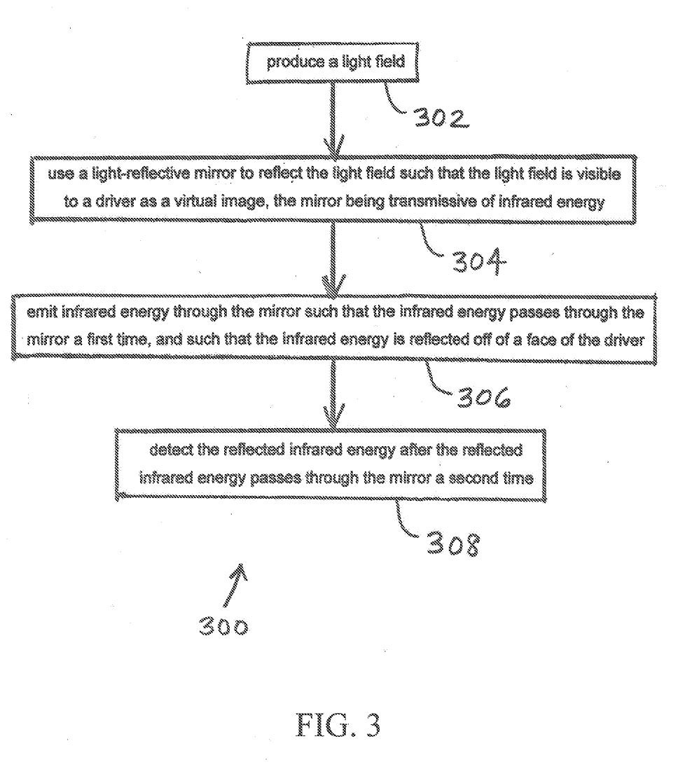

FIG. 3 illustrates one embodiment of a head up display method 300 of the present invention for a motor vehicle having a driver. In a first step 302, a light field is produced. For example, LCD 16 produces a light field.

In a next step 304, a light-reflective mirror is used to reflect the light field such that the light field is visible to the driver as a virtual image. The mirror is transmissive of infrared energy. For example, the light field may be reflected by mirror 14, then reflect off of reflector 12, and again be reflected off of windshield 22 such that the light field is visible to a human driver 28 as a virtual image 30. Cold fold mirror 14 may be transmissive of IR energy.

Next, in step 306, infrared energy is emitted through the mirror such that the infrared energy passes through the mirror a first time, and such that the infrared energy is reflected off of a face of the driver. For example, IR energy emitted from IR emitters 18a-b transmits through mirror 14, reflects off of reflector 12 and is again reflected off of windshield 22 before being yet again reflected off of the face of driver 28.

In a final step 308, the reflected infrared energy is detected after the reflected infrared energy passes through the mirror a second time. For example, The IR energy reflected off of the face of driver 28 reflects sequentially off of windshield 22 and reflector 12 before passing through mirror 14 a second time and being received and detected by IR camera 20 along optical path 26.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle having a human driver, comprising:
a picture generation unit configured to produce a light field;
a light-reflective mirror configured to reflect the light field such that the light field is visible to the driver as a virtual image, the mirror being transmissive of infrared energy;
an infrared energy emitter configured to emit infrared energy such that the infrared energy passes through the mirror a first time, and such that the infrared energy is reflected off of a face of the driver; and
an infrared camera configured to detect the reflected infrared energy after the reflected infrared energy then passes through the mirror a second time.

2. The head up display arrangement of claim 1 wherein the light field is reflected from the mirror and the reflected infrared energy approaches the mirror along a same optical path.

3. The head up display arrangement of claim 1 where the high reflective mirror is coated to reflect visible light and be transmissive to IR illumination.

4. The head up display arrangement of claim 1 further comprising a reflector configured to:
reflect the light field after the light field is reflected by the high reflective mirror; and
reflect the infrared energy after the infrared energy passes through the high reflective mirror the first time and before the infrared energy is reflected by the driver's face.

5. The head up display arrangement of claim 3 wherein the reflector is configured to again reflect the infrared energy after the infrared energy is reflected by the driver's face and before the reflected infrared energy passes through the mirror the second time.

6. The head up display arrangement of claim 4 further comprising:
an actuator coupled to the reflector and configured to adjust an orientation of the reflector; and
an electronic processor coupled to the actuator and to the infrared camera, wherein the electronic processor is configured to control the actuator to adjust the orientation of the reflector dependent upon signals the electronic processor receives from the infrared camera.

6. The head up display arrangement of claim 1 wherein the infrared energy emitter comprises a first infrared energy emitter, the head up display arrangement further comprising a second infrared energy emitter configured to emit infrared energy such that the infrared energy passes through the mirror, and such that the infrared energy is reflected off of a face of the driver.

7. The head up display arrangement of claim 6 wherein the first infrared energy emitter and the second infrared energy emitter are disposed on opposite sides of the infrared camera.

8. A head up display method for a motor vehicle having a driver, said method comprising:
producing a light field;
using a light-reflective mirror to reflect the light field such that the light field is visible to the driver as a virtual image, the mirror being transmissive of infrared energy;
emitting infrared energy through the mirror such that the infrared energy passes through the mirror a first time, and such that the infrared energy is reflected off of a face of the driver; and
detecting the reflected infrared energy after the reflected infrared energy passes through the mirror a second time.

9. The method of claim 8 wherein the light field is reflected from the mirror along a same optical path as the reflected infrared energy approaches the mirror.

10. The method of claim 8 further comprising using a reflector to:
reflect the light field after the light field is reflected by the mirror; and
reflect the infrared energy after the infrared energy passes through the mirror the first time and before the infrared energy is reflected by the driver's face.

11. The method of claim 10 further comprising using the reflector to again reflect the infrared energy after the infrared energy is reflected by the driver's face and before the reflected infrared energy passes through the mirror the second time.

12. The method of claim 11 further comprising:
coupling an actuator to the reflector;
coupling an electronic processor to the actuator and to the infrared camera; and
using the electronic processor to control the actuator to adjust an orientation of the reflector dependent upon signals the electronic processor receives from the infrared camera.

13. The method of claim 8 wherein the infrared energy is emitted from a first location, the method further comprising emitting infrared energy from a second location through the mirror such that the infrared energy passes through the mirror a first time, and such that the infrared energy is reflected off of a face of the driver.

14. The method of claim 13 wherein the reflected infrared energy is detected at a third location between the first location and the second location.

15. A head up display arrangement for a motor vehicle having a human driver, comprising:
a picture generation unit configured to produce a light field;
a light-reflective mirror configured to provide a first reflection of the light field, the mirror being transmissive of infrared energy;
two infrared energy emitters configured to emit infrared energy through the mirror;
a reflector configured to provide a first reflection of the infrared energy such that the infrared energy is reflected off of a face of the driver and a second reflection of the infrared energy is provided by the reflector, the reflector being configured to provide a second reflection of the light field such that the light field is visible to the driver as a virtual image; and
an infrared camera configured to detect the second reflection of the infrared energy after the second reflection of the infrared energy passes through the mirror.

16. The head up display arrangement of claim 15 wherein the infrared camera is disposed between the two infrared energy emitters.

17. The head up display arrangement of claim 15 wherein the light field is reflected from the mirror along an optical path, and the second reflection of the infrared energy approaches the mirror along the optical path.

18. The head up display arrangement of claim 15 wherein the second reflection of the infrared energy is provided by the reflector after the infrared energy is reflected by the driver's face and before the second reflection of the infrared energy passes through the mirror.

19. The head up display arrangement of claim 15 further comprising:
an actuator coupled to the reflector and configured to adjust an orientation of the reflector; and
an electronic processor coupled to the actuator and to the infrared camera, wherein the electronic processor is configured to control the actuator to adjust the orientation of the reflector dependent upon signals the electronic processor receives from the infrared camera.

20. The head up display arrangement of claim 15 wherein the reflector comprises a parabolic reflector or an aspheric reflector.
